(19) United States
(12) Patent Application Publication
(10) Pub. No.: US 2002/0045439 A1
(43) Pub. Date: Apr. 18, 2002

(54) Automatic sound reproducing function of cellular phone

(75) Inventor: Masayuki Kushita, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/974,957

(22) Filed: Oct. 11, 2001

(30) Foreign Application Priority Data
Oct. 11, 2000 (JP) 311044/2000

(51) Int. Cl. H04M 11/10

(52) U.S. Cl. 455/412; 455/413; 455/466; 455/566

(57) ABSTRACT

A method, which enables a user of a cellular phone to send a desired message to the other party when making a telephone call, is provided. When a user make a telephone call by a cellular phone, audio data stored in a memory in advance or audio data that are converted from text downloaded from the outside by an e-mail receiving function etc. or text inputted by operating a keyboard are automatically reproduced after a prescribed period of time has passed from when the cellular phone receives a CONN signal that is sent from a base station corresponding to a reply of the other party. After the reproduced voice message is transmitted to the other party, the call is automatically terminated (disconnected).

### BACKGROUND OF THE INVENTION

The present invention relates to a cellular phone provided with a function of delivering a requisite message that a calling party wish to tell to the other party without uttering a sound in an environment where it is awkward to communicate vocally such as on the train or during the meeting.

### DESCRIPTION OF THE RELATED ART

As a cellular phone of the sort, one having a function of reproducing prerecorded audio data (or audio data previously stored in a memory) to answer an incoming call has been known so far. Japanese Patent Application Laid-Open No. HEI4-20054, HEI4-351145, HEI6-30105 and HEI11-122675 disclose cellular phones provided with the function.

For example, there is described a technique in Japanese Patent Application Laid-Open No. HEI11-122675 for reproducing a message selected from a plurality of prerecorded voice messages when a call is received so that communication is achieved without speaking, namely, without bothering the others, and instantaneous communication is unspoilt.

Techniques disclosed in the above applications etc. intend to reply to a call or a message from the other party without speaking by means of sound reproduction rather than send information to the other party. Consequently, only formulaic messages such as a prerecorded audio response message are available for the reproduction, and thus communicable information is limited.

On the other hand, when a user conveys a message, for example, “I am on my way home” or “I am getting to the station soon” to his/her family by a cellular phone on the train, he/she has had no alternative but to tell the message via a microphone of the cellular phone with caring about those around him/her.

### SUMMARY OF THE INVENTION

It is therefore an object of the present invention to provide a method by which it is made possible to send a desired message without speaking aloud when making a telephone call under the condition that vocal communication on the cellular phone may cause a nuisance to the other people.

In accordance with the present invention, there is provided a cellular phone having a function of automatically reproducing and transmitting audio data previously stored in a memory, or audio data that are converted from text downloaded by an e-mail receiving function etc. or text inputted by operating a keyboard in response to a signal sent from a base station when the other party answer the call originated by a user.

In accordance with the present invention, when, for example, a user sends a voice message such as “I am on my way home” or “I am getting to the station soon” to his/her family by a cellular phone on the train, he/she can deliver a desired message to the other party without causing a nuisance to other passengers by speaking aloud.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a sequence of transmission control between a cellular phone (mobile device) and a base station;

FIG. 2 is a block diagram showing a configuration of a cellular phone in accordance with an embodiment of the present invention;

FIG. 3 is a block diagram showing an example of a characteristic part of the present invention illustrated in FIG. 2;

FIG. 4 is a flow chart showing operation when a CONN signal from the base station is received in the sequence illustrated in FIG. 1; and

FIG. 5 is a flow chart showing operation in the case where text is converted into audio data by DSP shown in FIG. 3 to execute sound reproduction.

### DESCRIPTION OF THE PREFERRED EMBODIMENT

Referring now to the drawings, a description of preferred embodiments of the present invention will be given in detail.

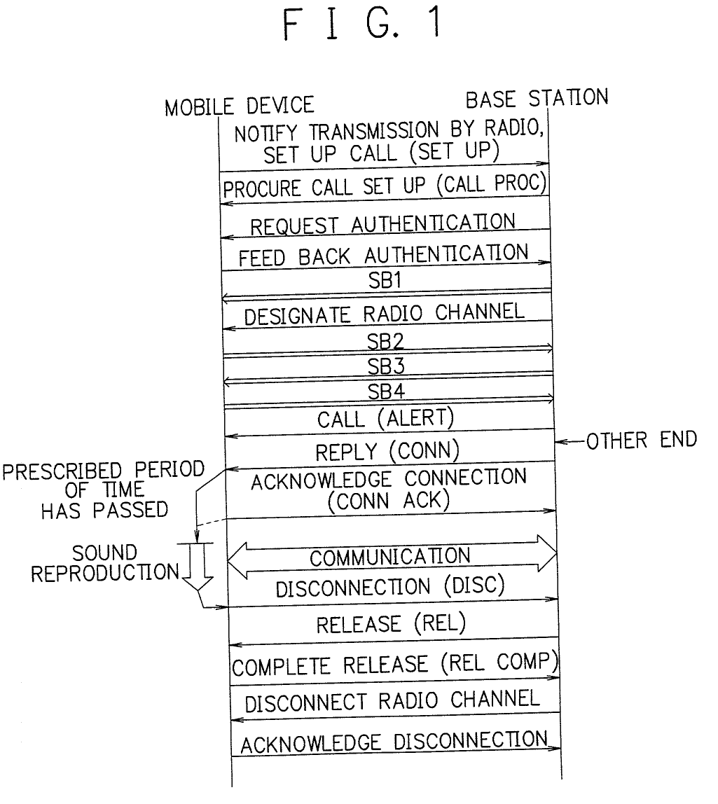

FIG. 1 is a diagram showing a sequence of transmission control procedures between a cellular phone (mobile device) of the present invention and a base station.

According to the present invention, audio data stored in a built-in memory of a mobile device is reproduced and transmitted to the other end after a predetermined period of time has passed from when the mobile device receives a connection (CONN) signal sent from a base station in response to an answer of the other party, or after transmitting a connection acknowledge (CONN ACK) signal corresponding to the reception of the CONN signal. After that, the mobile device transmits a disconnection (DISC) signal when the sound reproduction has been finished, and then the connection is automatically cleared (disconnected).

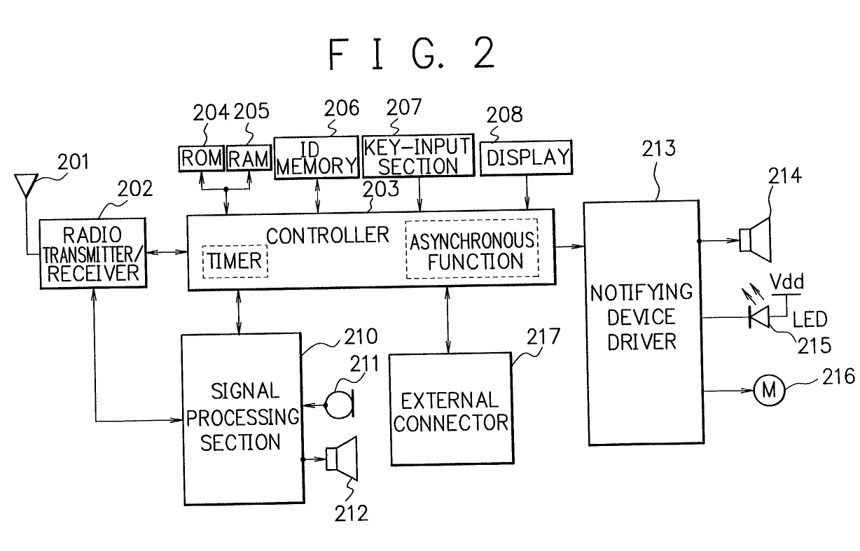

FIG. 2 is a block diagram showing a configuration of a cellular phone in accordance with an embodiment of the present invention.

In FIG. 2, a controller 203 is a section for controlling each part as well as performing control operations according to the present invention described below. For example, the controller 203 detects own identity code from paging signals demodulated at a radio transmitter/receiver 202 and controls a notifying device driver 213 to notify an incoming call by sound from a sounder 214, by light from an LED 215 or by vibration from a vibrator 216. The controller 203 also executes call out control in response to an input of the other party's telephone number from a key-input section 207 and a call out setup.

In addition, the controller 203 processes digital data signals that are not audio signals, and realizes an e-mail (electronic mail) transmitting/receiving function and a server connecting function. Generally, the controller 203 includes a clocking means such as a timer.

The own identity code stored in an ID memory 206 is read at the controller 203, and collated with data in a prescribed position of a demodulated signal. A ROM 204 is a memory for storing an operation program for the CPU of the controller and fixed data. A RAM 205 is a memory for storing data of mails received by the e-mail transmitting/receiving function as well as produced and transmitted mails. The RAM 205 is also used as a working memory when the CPU in the controller 203 is in operation.

A signal processing section 210 includes DSP (Digital Signal Processor) and the like. The signal processing section 210 performs A/D conversion for an audio signal supplied from a microphone 211 according to control by the controller 203, and subsequently the audio signal is compressed. After going through the compressing process, the signal is modulated at the radio transmitter/receiver 202 to generate audio data to be transmitted from an antenna 201. The signal processing section 210 also extracts audio data from a signal, which is received at the antenna 201 and demodulated at the radio transmitter/receiver 202. The signal is then uncompressed and D/A-converted to generate an audio signal to be outputted from a receiver 212.

An external connector 217 is mainly connected to an external device via a dedicated cable and used as a port for data communication with an external device employing an asynchronous function in the controller 203.

The key-input section 207 is used for inputting a telephone number when making a telephone call, text-entry such as registering a telephone number in a telephone directory, and settings for respective functions. A display 208 displays a telephone number when the mobile device originates/receives a call, contents of various inputs in association with the key-input section 207, and contents of a text mail received by the e-mail transmitting/receiving function.

The radio transmitter/receiver 202 demodulates a radio wave received at the antenna 201. The radio transmitter/receiver 202 also conducts phase modulation of a digital signal from the controller 203 or the signal processing section 210 and supplied the modulated signal to the antenna 201. The antenna 201 transmits/receives the phase-modulated radio wave.

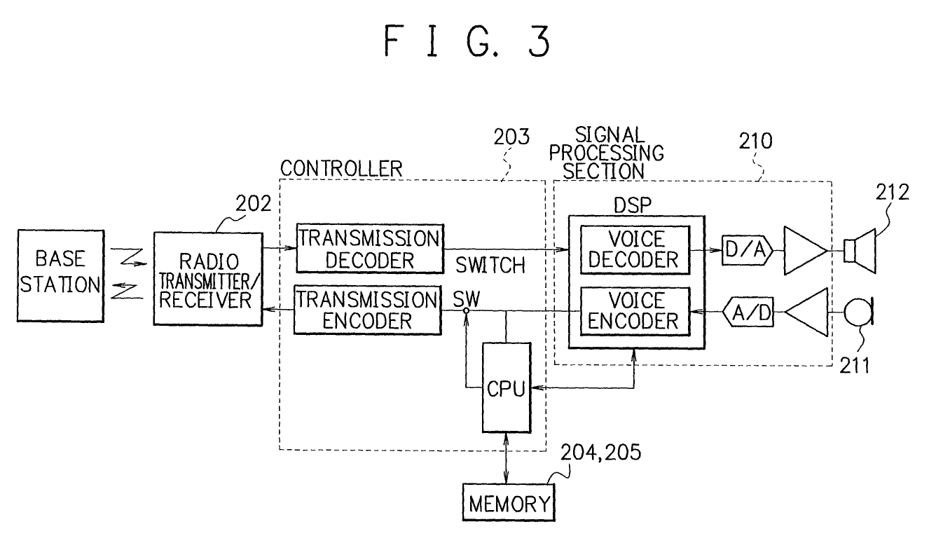

FIG. 3 is a block diagram showing an example of the configuration of FIG. 2 in detail with respect to a characteristic part of the present invention. The memory 204 (ROM) or 205 (RAM) previously stores fixed audio data, or recorded audio data that have been inputted from the microphone 211 and processed by the DSP in the signal processing section 210.

There is a switch (SW) in the controller 203 so that the switchover operation is performed between voice inputted from the microphone 211 and audio data stored in the memory to send either of them by radio. During a normal call, the SW is connected to the DSP side, while in the case where the audio data stored in the memory 204 or 205 is transmitted, the CPU switches the SW connection to the CPU side. The CPU then reads the data stored in a predetermined area of the memory and outputs the data.

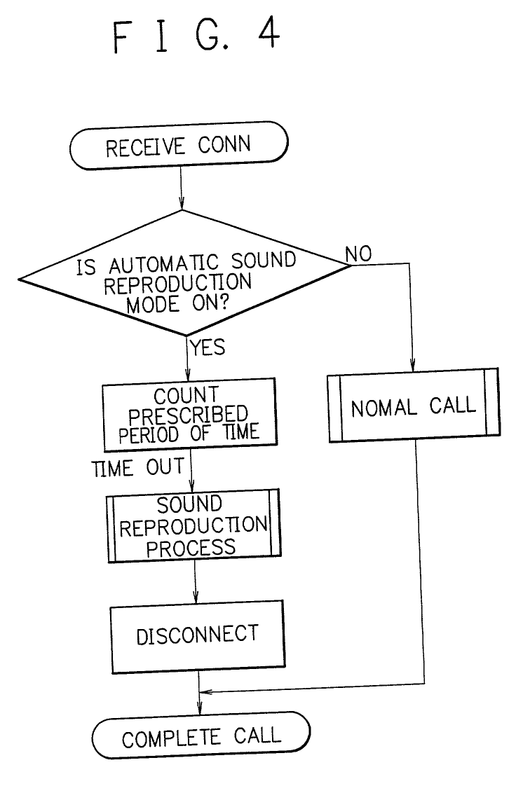

FIG. 4 is a flowchart showing operation according to the present invention at the time of reception of a CONN signal from a base station in the sequence of FIG. 1. In the following, the operation of this embodiment will be explained with reference to the flowchart of FIG. 4.

A mobile device according to the present invention is provided with a mode setup function for selecting whether or not to conduct automatic sound reproduction on the occasion of making a phone call. When the mode is selected so as not to conduct automatic sound reproduction, operation proceeds to normal call processes. In this case, the SW in FIG. 3 is connected to the DSP side.

In the case of selecting the automatic sound reproduction mode, in which audio data stored in the memory 204 or 205 are reproduced and transmitted, the SW in FIG. 3 is switched to the CPU side. When a call out is set up under this condition, predetermined audio data is read from the memory 204 or 205 after a prescribed period of time has passed from when the mobile device receives a CONN signal from a base station, and the audio data is automatically reproduced. After the sound reproduction is finished, the mobile device automatically performs the disconnecting operation, and thus terminating the call.

In addition, if audio data is stored as text (character) data, it is possible to check contents of the audio data in the course of being transmitted to the other party by displaying the data on the display 208 as a text message.

Incidentally, in the above embodiment, reproduction of audio data is automatically performed after a prescribed period of time has passed from when a mobile device receives a CONN signal from a base station. However, it is also possible to designate reproduction of predetermined audio data by using the key-input section 207 after the receiver 212 confirms a response from the other party during a call.

Moreover, in the above embodiment, as sound for automatically reproduced, predetermined audio data stored in the ROM 204 or a voice message, which has been converted into audio data by the signal processing section 210 and recorded in the RAM 205, is reproduced to be transmitted. However, automatic sound reproduction may be performed for text data using text-to-speech conversion or text-to-speech synthesizing technique (TTS). In this case, text data designated before originating a call are converted into audio data at the CPU and the DSP corresponding to reception of a CONN signal. Thereby the converted audio data are automatically reproduced

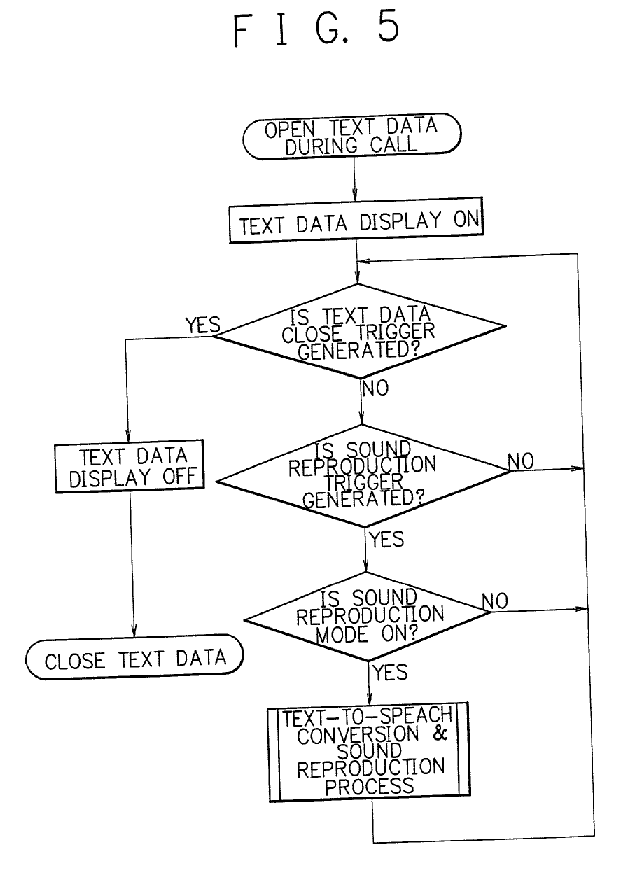

FIG. 5 is a flowchart showing operation according to another embodiment of the present invention in which text-to-speech conversion is executed by the DSP in FIG. 3 to reproduce sound.

In FIG. 5, when a user invokes text data by operating a keyboard during a call, the text data is displayed on the display section. In the case where a key operation for sound reproduction is conducted while the text data is shown on the display, it is judged that whether or not sound reproduction mode is selected. If the reproduction mode is selected, the text data is converted into speech to be reproduced.

On the other hand, when a mobile device is set to non-sound reproduction mode, the key operation for sound reproduction is ignored. Besides, if a key operation for closing the text data is performed, the display is closed. A user conducts mode selection to reproduce or not to reproduce sound by a key operation in advance.

Here, in FIG. 3, text data is maintained in either of the memories of the CPU. The CPU also executes display operation and processes according to key operations. When sound reproduction is performed by a key operation accordingly, the CPU supplies the text data (character code data) to the DSP so that text-to-speech conversion is executed at the DSP. Incidentally, on this occasion, the SW is always connected to the DSP side.

As set forth hereinabove, according to this embodiment, text data are displayed during a call, and then converted into audio data to be reproduced. Thus it is possible to conduct sound reproduction and deliver a message after checking the other party's response to know if the responder is a desired person or an answering machine etc. Additionally, by converting text data into audio data for reproduction, more information can be delivered to the other party.

Moreover, in this configuration, it is also possible to reproduce text data inputted during a call by a key operation. On this occasion, the inputted text is converted into speech with a prescribed key operation set as a trigger.

Incidentally, in this embodiment, sound reproduction is not automatically executed corresponding to receipt of a CONN signal as illustrated in FIG. 1, but executed after text-to-speech conversion of text data invoked during a call. However, similarly to the case of FIG. 1, it is possible that text data is invoked automatically after receipt of a CONN signal and converted into audio data to be reproduced and transmitted.

Furthermore, text data that is invoked during a call is not limited to an item of text data. It is also possible to continuously transmit plural items of text data in succession. In such case, plural items of text data are stored in the memory. When transmission of an item of converted audio data comes to an end, the completion of transmission is indicated on the display panel, and thereby another item of text data stored in the memory is invoked while retaining the call. The text data is supplied to the text-to-speech converter to be converted into audio data, and then sent to the radio transmitter/receiver.

On this occasion, the number and order of the text data to be read out of the memory and sequentially transmitted to the radio transmitter/receiver are specified while retaining the call, thus enabling transmission of more complex text data relatively easily.

In a cellular phone in accordance with the present invention, when a user originates a call, audio data that is previously stored in a memory is automatically reproduced corresponding to a signal sent from a base station due to a response of the other party. Thus, it is possible to deliver a requisite message that the user wish to tell to the other party without uttering a sound in an environment where it is awkward to communicate vocally such as on the train or during the meeting.

Additionally, a cellular phone of the present invention is capable of converting text inputted by a user from an input device or a mail received from the outside of the cellular phone into speech data to deliver the data to the other party. Therefore, a, broader variety of information can be communicated in comparison with a conventional cellular phone capable of only sending a response massage.

While the preferred embodiments of the present invention have been described using specific terms, such description is for illustrative purposes only, and it is to be understood that changes and variations may be made without departing from the spirit or the scope of the following claims.

What is claimed is:

1. An automatic sound transmitting method of a cellular phone in acknowledgment of a response of the other party when calling up, comprising the steps of:
receiving a signal sent from a base station corresponding to a response of the other party to a call setup operation from a key-input section of a cellular phone;
reproducing audio data previously recorded and stored in a memory or synthetic audio data previously stored in a memory;
transmitting the reproduced audio data to the other party via a radio transmitter/receiver; and
automatically terminating the call or disconnecting after the reproduction and transmission of the audio data are completed.

2. An automatic sound transmitting method of a cellular phone in acknowledgment of a response of the other party when calling up as claimed in claim 1, wherein contents of the reproduced audio data are displayed on a display as text data during the transmission.

3. An automatic sound transmitting method of a cellular phone in acknowledgment of a response of the other party when calling up as claimed in claim 1, wherein the reproduction of the audio data can be designated during the call including the point of time of reception.

4. An automatic sound transmitting method of a cellular phone in acknowledgment of a response of the other party when calling up as claimed in claim 2, wherein the reproduction of the audio data can be designated during the call including the point of time of reception.

5. An automatic sound transmitting method of a cellular phone in acknowledgment of a response of the other party when calling up, comprising the steps of:
receiving a signal sent from a base station corresponding to a response of the other party to a call setup operation from a key-input section of a cellular phone;
reading out text data stored in a memory;
converting the text data into audio data at a text-to-speech converter;
transmitting the converted audio data to the other party via a radio transmitter/receiver; and
automatically terminating the call or disconnecting after the transmission of the audio data is completed.

6. An automatic sound transmitting method of a cellular phone in acknowledgment of a response of the other party when calling up as claimed in claim 5, wherein contents of the text data are displayed on a display during the transmission.

7. An automatic sound transmitting method of a cellular phone in acknowledgment of a response of the other party when calling up as claimed in claim 5, wherein the readout of the text data can be designated during the call including the point of time of reception.

8. An automatic sound transmitting method of a cellular phone in acknowledgment of a response of the other party when calling up as claimed in claim 6, wherein the readout of the text data can be designated during the call including the point of time of reception.

9. An automatic sound transmitting method of a cellular phone in acknowledgment of a response of the other party when calling up as claimed in claim 7, further comprising the steps of:
indicating completion of the transmission on the display after the transmission of the converted audio data is finished;
reading out another item of text data stored in the memory and supplying the text data to the text-to-speech converter while retaining the call;
converting the text data into audio data at the text-to-speech converter; and
sending the converted audio data to the radio transmitter/receiver in succession.

10. An automatic sound transmitting method of a cellular phone in acknowledgment of a response of the other party when calling up as claimed in claim 8, further comprising the steps of:
indicating completion of the transmission on the display after the transmission of the converted audio data is finished;
reading out another item of text data stored in the memory and supplying the text data to the text-to-speech converter while retaining the call;
converting the text data into audio data at the text-to-speech converter; and
sending the converted audio data to the radio transmitter/receiver in succession.

11. A cellular phone comprising:
a key-input section for inputting a telephone number when making a phone call, a text-entry and settings for respective functions;
a radio transmitter/receiver for communicating with a base station by radio;
memories for storing previously recorded audio data and/or synthetic audio data; and
a controller which includes: a means for originating a call of a telephone number when the telephone number and a call up setup are inputted from the key-input section, a means for reading out the previously recorded audio data or the synthetic audio data stored in one of the memories on receipt of a signal sent from the base station corresponding to a response of the other party to the call, a means for sending the read audio data to the radio transmitter/receiver, and a means for terminating the call or disconnecting after the transmission of the read audio data is completed.

12. A cellular phone as claimed in claim 11, further including a means for displaying contents of the reproduced audio data on a display as text data during the transmission.

13. A cellular phone as claimed in claim 11, further including a means for designating the reproduction of the audio data during the call including the point of time of reception.

14. A cellular phone as claimed in claim 12, further including a means for designating the reproduction of the audio data during the call including the point of time of reception.

15. A cellular phone comprising:
a key-input section for inputting a telephone number when making a phone call, a text-entry and settings for respective functions;
a radio transmitter/receiver for communicating with a base station by radio;
memories for storing inputted character data as text data;
a text-to-speech converter for converting the text data into audio data; and
a controller which includes: a means for originating a call of a telephone number when the telephone number and a call up setup are inputted from the key-input section, a means for reading out the text data stored in one of the memories on receipt of a signal sent from the base station corresponding to a response of the other party to the call and supplying the text data to the text-to-speech converter in order to convert the text data to audio data, a means for sending the converted audio data to the radio transmitter/receiver, and a means for terminating the call or disconnecting after the transmission of the converted audio data is completed.

16. A cellular phone as claimed in claim 15, further including a means for displaying contents of the text data on a display during the transmission.

17. A cellular phone as claimed in claim 15, further including a means for designating the readout of the text data during the call including the point of time of reception.

18. A cellular phone as claimed in claim 16, further including a means for designating the readout of the text data during the call including the point of time of reception.

19. A cellular phone as claimed in claim 17, wherein:
either/both of the memories store plural items of text data; and
the controller further includes: a means for indicating completion of transmission on the display every time one of the plural items of text data has been converted into audio data and transmitted, a means for reading out another item of text data stored in one of the memories while retaining the call and supplying the text data to the text-to-speech converter in order to convert the text data to audio data, and a means for continuously sending the converted audio data to the radio transmitter/receiver.

20. A cellular phone as claimed in claim 18, wherein:
either/both of the memories store plural items of text data; and
the controller further includes: a means for indicating completion of transmission on the display every time one of the plural items of text data has been converted into audio data and transmitted, a means for reading out another item of text data stored in one of the memories while retaining the call and supplying the text data to the text-to-speech converter in order to convert the text data to audio data, and a means for continuously sending the converted audio data to the radio transmitter/receiver.

21. A cellular phone as claimed in claim 19, further including a means for designating the number and order of the text data to be read out and transmitted to the radio transmitter/receiver in succession.

22. A cellular phone as claimed in claim 20, further including a means for designating the number and order of the text data to be read out and transmitted to the radio transmitter/receiver in succession.
